(19) United States
(12) Patent Application Publication
(10) Pub. No.: US 2020/0308002 A1
(43) Pub. Date: Oct. 1, 2020

(54) CARBON NANOTUBE FIBER MANUFACTURING APPARATUS AND METHOD

(71) Applicants: Alexander Moravsky, Houston, TX (US); Valery Khabashesku, Houston, TX (US); Raouf Loutfy, Houston, TX (US)

(72) Inventors: Alexander Moravsky, Houston, TX (US); Valery Khabashesku, Houston, TX (US); Raouf Loutfy, Houston, TX (US)

(73) Assignee: Baker Hughes Oilfield Operations LLC, Houston, TX (US)

(21) Appl. No.: 16/370,195

(22) Filed: Mar. 29, 2019

(51) Int. Cl. C01B 32/164; C01B 32/159; C01B 32/162

(52) U.S. Cl. CPC C01B 32/164; C01B 32/159; C01P 2004/133; C01B 2202/02; C01B 2202/04; C01B 32/162

(57) ABSTRACT

An apparatus for performing aspects of manufacturing carbon nanotubes includes a nozzle configured to receive a catalyst precursor solution and a carrier gas, the nozzle including an orifice configured to nebulize the catalyst precursor solution and produce a mist including a mixture of the nebulized catalyst precursor solution and the carrier gas, the nozzle configured to inject the mist directly into a high temperature reaction zone of a reactor. The apparatus also includes an elongated tubular body having a first conduit and a second conduit, and a cooling system configured to regulate a temperature of the catalyst precursor solution and the carrier gas along the length of the tubular body. The first conduit and the second conduit extend along a length of the tubular body, and the length of the tubular body is greater than or equal to a distance from an end of the reactor to the reaction zone.

### BACKGROUND

Carbon nanotubes (CNTs) are allotropes of carbon with a cylindrical nanostructure. CNTs have unusual thermal, electrical, strength and optical properties. Such properties are valuable in a variety of fields, such as the military, aerospace, and energy fields. CNTs are also useful in the resource recovery industry and have applicability to various operations, such as drilling, completion, production and refining. For example, CNTs can be used to enhance drilling fluids, improve cooling due to their high thermal conductivity, and enhance oil recovery.

### SUMMARY

An embodiment of an apparatus for performing aspects of manufacturing carbon nanotubes includes a nozzle configured to receive a catalyst precursor solution and a carrier gas, the nozzle having a distal end including an orifice configured to nebulize the catalyst precursor solution and produce a mist including a mixture of the nebulized catalyst precursor solution and the carrier gas, the nozzle configured to inject the mist directly into a high temperature reaction zone of a reactor. The apparatus also includes an elongated tubular body having a first conduit and a second conduit in fluid communication with the nozzle, and a cooling system configured to regulate a temperature of the catalyst precursor solution and the carrier gas along the length of the tubular body. The first conduit and the second conduit extend along a length of the tubular body, where one of the first conduit and the second conduit is connected to a source of a catalyst precursor solution, another of the first conduit and the second conduit is connected to a source of the carrier gas, and the length of the tubular body is greater than or equal to a distance from an end of the reactor to the reaction zone.

An embodiment of a method of performing aspects of manufacturing carbon nanotubes includes supplying a catalyst precursor solution and a carrier gas to an injection assembly, the injection assembly including a nozzle and an elongated tubular body having a first conduit and a second conduit in fluid communication with the nozzle, the first conduit and the second conduit extending along a length of the tubular body, one of the first conduit and the second conduit receiving the catalyst precursor solution, another of the first conduit and the second conduit receiving the carrier gas. The method also includes inserting the length of the tubular body through an end of the reactor to a reaction zone in the reactor and disposing the nozzle in the immediate region of the high temperature reaction zone, regulating a temperature of the catalyst precursor solution and the carrier gas along the length of the tubular body by a cooling system, nebulizing the catalyst precursor solution to produce a mist including a mixture of the nebulized catalyst precursor solution and the carrier gas, and injecting the mist into the reaction zone when the nozzle is disposed in the reaction zone.

### BRIEF DESCRIPTION OF THE DRAWINGS

Referring now to the drawings wherein like elements are numbered alike in the several Figures:

FIG. 1 depicts an embodiment of a system for manufacturing carbon nanotubes, which includes a thermal chemical vapor deposition reactor;

FIG. 2 depicts an embodiment of an injection assembly for supplying precursor components to the reactor of FIG. 1;

FIG. 3 depicts a portion of the injection assembly of FIG. 2;

FIG. 4 depicts a portion of the injection assembly of FIGS. 2 and 3 including an injection nozzle;

FIG. 5 is a cross-sectional view of a portion of an injection assembly including an injection nozzle; and

FIG. 6 is a flow chart depicting aspects of a method of manufacturing carbon nanotubes.

### DETAILED DESCRIPTION

Apparatuses, systems and methods for manufacturing carbon nanotubes (CNTs) are described herein. An embodiment of an injection assembly includes an elongated tubular body in fluid communication with a nozzle configured to nebulize a catalyst precursor solution and inject a fine mist including a mixture of the catalyst precursor solution and a carrier gas directly into a high temperature reaction region of a reactor. A high temperature zone or high temperature reaction zone is a region of the reactor having a higher temperature (a reaction temperature) than other regions of the reactor. In one embodiment, the reactor is configured to produce CNTs by a chemical vapor deposition (CVD) process, such as a floating catalyst thermal CVD process.

The injection assembly includes a first conduit and a second conduit that extend along a length of the tubular body and are in fluid communication with the nozzle. In one embodiment, the injection assembly includes a cooling system such as a fluid or water jacketing system that regulates the temperature of the catalyst precursor solution and the carrier gas by circulating water or another cooling liquid along the length. The cooling system allows the length of the tubular body to be inserted through an end of the reactor, and allows the nozzle to be disposed in the reaction zone prior to injecting the mist into the reaction zone.

In one embodiment, the first and second conduits terminate at or near an orifice of the nozzle, so that the catalyst precursor solution and the carrier gas are not combined until they reach the orifice. In this way, the catalyst precursor solution and the carrier gas are combined as the catalyst precursor solution advances through the orifice and is nebulized.

Embodiments described herein provide a number of advantages. For example, the injection assembly described herein is capable of producing very small particles of catalyst, which facilitates the formation of single and double-walled CNTs by preventing the conversion of a catalyst precursor solution into larger catalyst particles, e.g., particles of a size that can result in CNTs with more than two walls. In addition, the injection assembly allows for a nozzle to be inserted into the hot zone of a reactor, which also serves to prevent the accumulation of larger catalyst particles, and results in longer CNTs and in CNT fibers having a higher strength than those produced using conventional injectors.

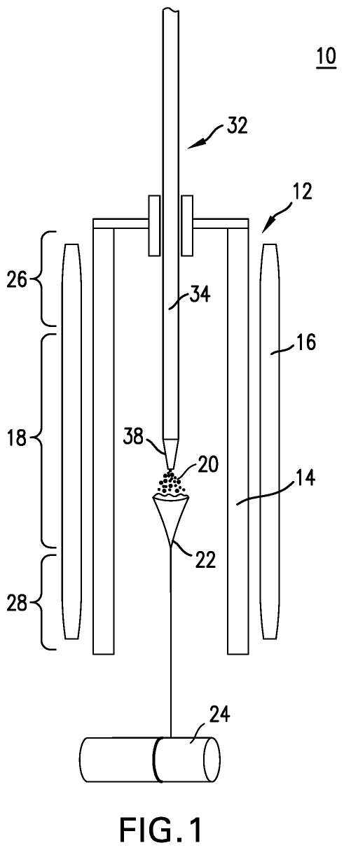

FIG. 1 illustrates an embodiment of a system 10 for manufacturing carbon nanotubes (CNTs). In this embodiment, the system 10 is configured to produce CNT fibers based on a thermal chemical vapor deposition (CVD) process. The system 10 includes a reactor 12 having a cylindrical elongated tube 14 made from a thermal refractory material such as a ceramic material. The reactor 12 may have any suitable size or length. For example, the reactor tube 14 is about 3 meters long and has a diameter of about 4 inches.

A heating element 16 is positioned proximate to the reactor tube 14 in order to heat a volume or region 18 (the reaction region) to a temperature sufficient to cause a reaction between injected precursor substances and formation of CNTs. For example, prior to injecting the precursor substances, the reactor tube 14 is heated so that the reaction region 18 (or high temperature reaction zone) reaches a selected reaction temperature, e.g., about 1200 degrees Celsius. The heating element 16 can be, for example, a resistive heating element such as a heating coil.

In one embodiment, the system 10 is configured to form CNTs using a high temperature floating catalyst method. To form the CNTs, precursor substances including a catalytic metal-based compound and a carbon source is delivered to the reactor 12 along with a carrier gas such as hydrogen, argon or nitrogen gas. In one embodiment, the metal-based catalyst precursor and the carbon source is injected into the reactor 12 as a liquid solution, referred to herein as a catalyst precursor solution. An example of a catalyst precursor solution is a solution of an organo-iron compound such as ferrocene. Various other solutions having a metal catalyst precursor and carbon source may be used.

The catalyst precursor solution and the carrier gas are delivered into the reactor tube 14 by nebulizing and injecting the catalyst precursor solution together with the carrier gas as a fine mist 20. The heat in the reaction region 18 causes decomposition of the catalyst precursor and of the carbon source followed by the growth of individual CNTs on catalyst particles (e.g., iron) in the presence of the carrier gas, the CNTs aggregating in the CNT fiber 22.

In one embodiment, the CNT fibers 22 are mechanically extracted from the reactor tube 14. For example, the system 10 includes a spinner 24 that extracts and collects the CNT fibers 22.

Reactors such as the reactor 12 of FIG. 1 typically have an uneven heat distribution along the longitudinal axis of the reactor. For example, when the reactor tube 14 is heated, the reaction region 18 is heated to the reaction temperature; however, regions 26 and 28 closer to the ends of the reactor tube 14 have lower temperatures. If the mist 20 is injected at or near the end of the reactor tube 14, for example in the region 26 (which is typically the case for conventional systems), the mist 20 must travel through a lower temperature region before entering the reaction region 18. In this instance, iron metal catalyst particles grow gradually to a relatively low number density as the mist 20 travels to the high temperature reaction region 18, which can result in large particles that produce multi-walled CNTs (i.e., CNTs having more than two walls), as opposed to single or double-walled CNTs.

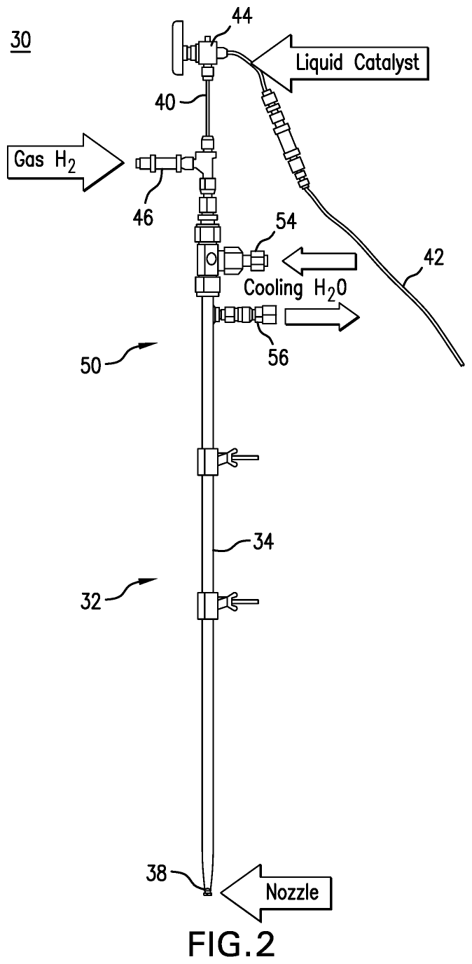

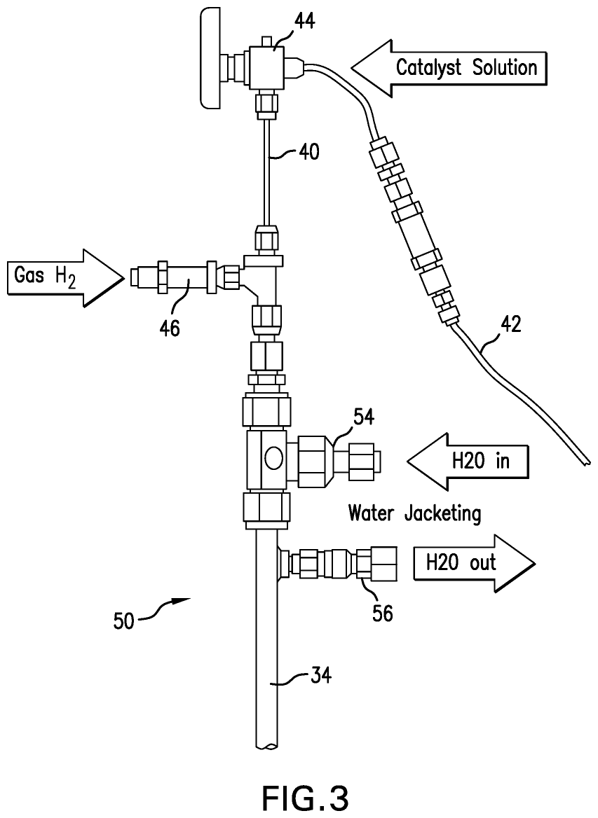

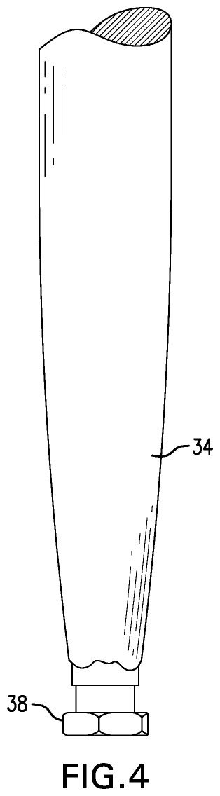

Referring to FIGS. 2-4, an injection assembly 30 is provided that is capable of injecting the mist 20 directly into the high temperature reaction zone 18, so that a much higher number density of metal catalyst particles is formed and growing of CNTs immediately commences, which prevents the formation of larger particles that can result in multi-walled CNTs having more than two walls. In addition, as discussed further below, the injection assembly 30 is capable of producing very small submicron droplets, which reduces the size of metal particles and prevents the formation of multi-walled CNTs.

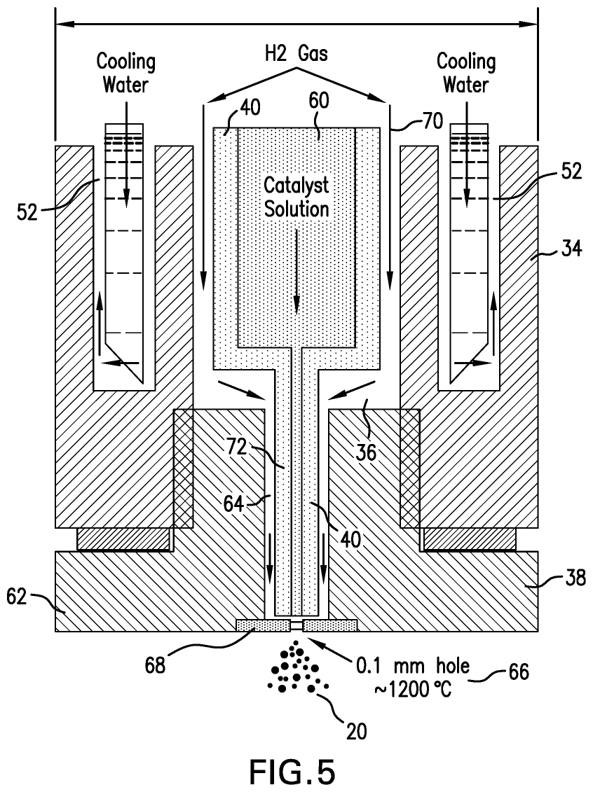

In one embodiment, the injection assembly 30 includes a nebulizer 32 having an elongated tubular body 34 made from stainless steel or other material capable of withstanding the high temperatures in the reactor 12. The tubular body 34 has a first conduit configured as a central conduit 36 (an example of which shown in FIG. 5) that is in fluid communication with a nozzle 38. The central conduit 36 is configured to receive an inner catalyst injection tube 40 that forms a second conduit. The catalyst injection tube 40 receives a catalyst precursor solution from a supply line 42 connected to a control valve 44 or other input location to the nozzle 38. The supply line 42 is configured to inject the solution at a high pressure, e.g., in the range of about 100 to about 700 psi.

The catalyst precursor solution includes a carbon source (e.g., a hydrocarbon such as ethanol) and metal catalyst precursor such as ferrocene, as well as a catalyst promoter such as thiophene. The precursor catalyst solution provides the carbon that forms the CNTs.

The catalyst injection tube 40 has a diameter that is less than the diameter of the injection conduit 36 and the internal diameter of the tubular body 34, such that a concentric or annular space is established between the catalyst injection tube 40 and an inner surface of the tubular body 34. A gas input port 46 is configured to inject a carrier gas (e.g., H₂) into the tubular body 34 and into the annular space. The carrier gas may be injected at a similar but slightly lower pressure than the catalyst precursor solution.

To regulate the temperature of the catalyst precursor solution and the carrier gas, and permit the nebulizer 32 and at least a portion of the tubular body 34 to be inserted into the hot reaction region 18, the injection assembly 30 includes a cooling system 50 that cools the catalyst precursor solution and the carrier gas as they travel along the tubular body 34 into the nozzle 38. The cooling system 50 is configured to cool the catalyst precursor solution and the carrier gas along a length of the tubular body that is greater than a distance from an end of the reactor tube 14 to the reaction region 18, which permits the length to be inserted through the reaction tube 14 so that the nozzle 38 is in the reaction zone 18 when the mist 20 is emitted from the nozzle 38.

In one embodiment, the cooling system 50 is a fluid jacketing system that circulates water or another cooling liquid into a circumferential cooling liquid conduit 52 (an example of which is shown in FIG. 5) formed within a wall of the tubular body 34. The cooling liquid conduit 52 surrounds the central conduit 36 and the injection tube 40. The cooling system 50 in this embodiment is configured to circulate cooling liquid through an input port 54, along the cooling liquid conduit 52, and out through an output port 56.

The cooling liquid conduit 52 extends along the tubular body 34 and terminates at or near the nozzle 38, such that the catalyst precursor solution and the carrier gas is cooled along the length from the input port 54 and/or the output port 56 to the injection nozzle 38. The catalyst precursor solution and the carrier gas are cooled along the length of the cooling fluid conduit 52 from the input port 54 to the nozzle 38, and the length is selected to be at least as long as the distance from an end of the reactor tube 14 to the reaction region 18. In this way, the nozzle 38 can be inserted into the reaction region 18 and the mist 20 can be emitted directly into the reaction zone 18 without requiring the mist 20 to travel through relatively cooler zones of the reactor tube 14. Emission of the mist 20 directly into the reaction region 18 avoids detrimental gradual heating of the mist 20 and gas born products vaporized from liquid droplets.

The cooling liquid can be injected and circulated at high flow rates and can maintain the temperature of the tubular body 34 and the nozzle 38 at a relatively low temperature, for example, at about 45 degrees Celsius or less. In addition to allowing for the direct injection of the mist 20 into the reaction region 18, the cooling system 50 allows for the use of low-boiling solvents for catalyst precursor solutions, and prevents the formation of detrimental precipitates from catalyst precursor components.

FIG. 5 is a cross-sectional view of a portion of an embodiment of the nebulizer 32 and the injection nozzle 38. The tubular body 34 terminates at and is configured to retain the nozzle 38, which forms an orifice having a diameter configured to nebulize a catalyst precursor solution 60 into fine droplets having a size that is about one micron or less. For example, the nozzle 38 has a body 62 that includes a channel 64 in fluid communication with the central conduit 36. The channel 64 allows fluid to flow to the distal end of the nozzle 38 and through an orifice 66, which can be integral to the nozzle body 62 or formed in a tip or end plate 68. For example, the end plate 68 is a membrane having a laser drilled orifice.

As noted above, the orifice 66 has a size or diameter configured to break up or nebulize the catalyst precursor solution into droplets having micron or submicron sizes. For example, the orifice 66 has a diameter of about 100 microns or 0.1 millimeters, or less. It is noted that the orifice 66 may have any suitable size or diameter for producing micron or submicron droplets and is not limited to this example.

The nebulizer 32, in one embodiment, is configured to isolate the catalyst precursor solution from the carrier gas until the catalyst precursor solution and the carrier gas reach a location at or proximate to the orifice 66, to avoid mixing the two prior to nebulizing the catalyst precursor solution. This also avoids premature heating of the solution and gas mixture, and therefore facilitates the formation of single walled and double walled CNTs while avoiding the formation of CNTs having more than two walls.

For example, the catalyst precursor solution 60 is isolated from a carrier gas 70 due to the central injection tube 40 extending to a location at or proximate to the orifice 66. As shown in FIG. 5, the central injection tube 40 extends through the channel 64 and terminates at or near the orifice 66. Thus, the catalyst precursor solution 60 and the carrier gas 70 do not combine or mix until both the catalyst precursor solution 60 and the carrier gas 70 reach the orifice 66. In one embodiment, the injection tube 40 has an end portion 72 that has a diameter less than the diameter of the channel 64 and terminates at or near the end of the channel 64.

As the catalyst precursor solution 60 and the carrier gas 70 are not combined until they are at or near the orifice 66, the contact area and time between the catalyst precursor solution 60 and the carrier gas 70 is minimized. This minimizes or eliminates the concentration and precipitation of catalyst precursor, ferrocene, in the nozzle 38, thereby preventing nozzle obstruction and clogging.

The nebulizer 32 is capable of producing a very fine (e.g., submicron) mist at low delivery rates both of liquid and gas fluids. For example, the catalyst precursor solution 60 can be delivered at a flow rate of about 0.1 milliliters/minute and combined with carrier gas 70 that is injected with a low gas delivery flow rate (e.g., about 1 Liter/minute). Such low flow rates can be used due to the small diameter of the exit orifice 66, which ensures high ejection speed and accordingly fine dispersion, provided sufficient pressures applied. In addition, the nebulizer 32 is scalable for larger reactors and can inject at higher rates (e.g., about 1-2 ml/min) if desired for scaled-up operations.

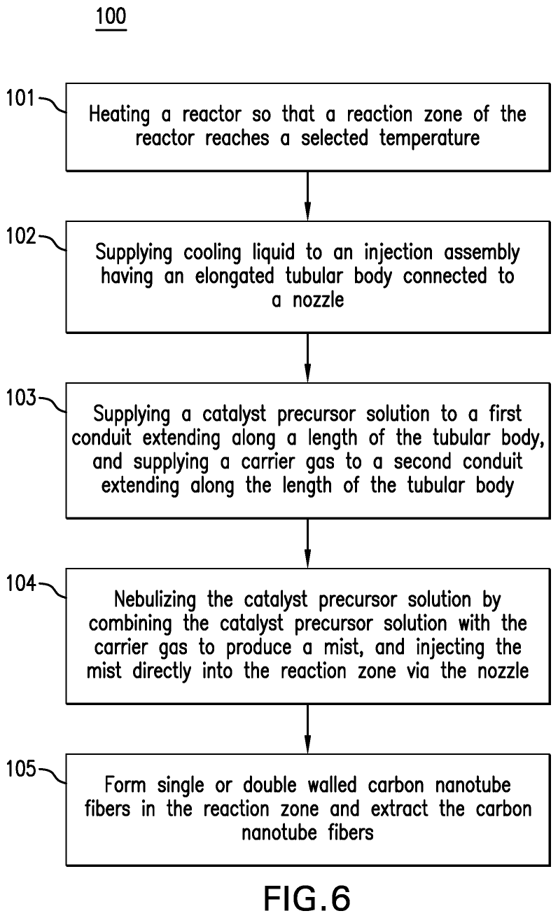

FIG. 6 illustrates a method 100 of manufacturing CNTs, including single and/or double-walled CNTs. The method 100 includes one or more stages 101-105. In one embodiment, the method 100 includes the execution of all of stages 101-105 in the order described. However, certain stages may be omitted, stages may be added, or the order of the stages changed.

The method 100 is discussed in conjunction with the reactor 12 of FIG. 1 but can be used with any suitable system for performing thermal chemical vapor deposition and producing CNTs therefrom. The method 100 is also discussed as being performed using the injection assembly 30, but is not so limited, and can be performed using any injection device or assembly having features described herein.

In the first stage 101, a reactor such as the reactor 12 is heated so that a zone or region such as the reaction region 18 reaches a selected temperature, e.g., about 1200 degrees Celsius. A length of the tubular body 34 of the injection assembly 30 is inserted into the reactor tube 14 until the nozzle 38 is located within the immediate region of the reaction region 18.

In the second stage 102, at least the length of the tubular body 34 is cooled using a cooling liquid. For example, a cooling liquid such as water is circulated through the cooling liquid conduit 52 that surrounds both the central conduit 36 and the catalyst injection tube 40. As shown in FIG. 5, the cooling liquid travels axially along the tubular body 34 from the input port 54 to a location near the nozzle 38.

In the third stage 103, a catalyst precursor solution such as a ferrocene solution is supplied to a first conduit extending along the length of the tubular body 34, and a carrier gas such as hydrogen gas is supplied to a second conduit extending along the length of the tubular body 34. For examples, the catalyst precursor solution is supplied to the catalyst injection tube 40 and a carrier gas such as hydrogen gas is supplied to the central conduit 36.

In the fourth stage 104, the catalyst precursor solution and the carrier gas combine at or near the nozzle orifice 66. The catalyst solution and the carrier gas combine as the solution is injected through the nozzle 66 and nebulized, and a mist 20 including the catalyst precursor solution and the carrier gas is injected directly into the reaction region 18.

In the fifth stage 105, CNTs are formed in the reaction region 18, continuously producing a hollow cylindrical shape product, a.k.a. sock, that is transformed into a CNT fiber 22 as extracted from the reactor tube 14, and which fiber can be used for a variety of applications.

Set forth below are some embodiments of the foregoing disclosure:

### Embodiment 1

An apparatus for performing aspects of manufacturing carbon nanotubes, comprising: a nozzle configured to receive a catalyst precursor solution and a carrier gas, the nozzle having a distal end including an orifice configured to nebulize the catalyst precursor solution and produce a mist including a mixture of the nebulized catalyst precursor solution and the carrier gas, the nozzle configured to inject the mist directly into a high temperature reaction zone of a reactor; an elongated tubular body having a first conduit and a second conduit in fluid communication with the nozzle, the first conduit and the second conduit extending along a length of the tubular body, one of the first conduit and the second conduit connected to a source of a catalyst precursor solution, another of the first conduit and the second conduit connected to a source of the carrier gas, the length of the tubular body being greater than or equal to a distance from an end of the reactor to the reaction zone; and a cooling system configured to regulate a temperature of the catalyst precursor solution and the carrier gas along the length of the tubular body.

### Embodiment 2

The apparatus of any prior embodiment, wherein the apparatus and the reactor are configured to produce carbon nanotubes by a floating catalyst thermal chemical vapor deposition process.

### Embodiment 3

The apparatus of any prior embodiment, further comprising an injection tube disposed in a central conduit of the tubular body, the first conduit formed by the injection tube and the second conduit being an annular region of the central conduit around the injection tube.

### Embodiment 4

The apparatus of any prior embodiment, wherein the cooling system is configured to circulate a cooling liquid along the length of the tubular body.

### Embodiment 5

The apparatus of any prior embodiment, wherein the cooling system includes a circumferential conduit extending along the length of the tubular body and configured to receive the cooling liquid, the circumferential conduit surrounding the first conduit and the second conduit.

### Embodiment 6

The apparatus of any prior embodiment, wherein the first conduit is a central conduit of the tubular body, the second conduit is formed by an injection tube disposed in the central conduit, and the circumferential conduit is formed within a wall of the tubular body.

### Embodiment 7

The apparatus of any prior embodiment, wherein the orifice is configured to nebulize the catalyst precursor solution into droplets having a size that is less than or equal to one micron.

### Embodiment 8

The apparatus of any prior embodiment, wherein the first conduit and the second conduit are configured to isolate the catalyst precursor solution from the carrier gas as the catalyst precursor solution and the carrier gas flow to the nozzle.

### Embodiment 9

The apparatus of any prior embodiment, wherein the first conduit and the second conduit terminate proximate to the orifice, so that the catalyst precursor solution and the carrier gas combine as the catalyst precursor solution and the carrier gas pass through the orifice.

### Embodiment 10

The apparatus of any prior embodiment, wherein the carbon nanotubes are selected from at least one of single-walled carbon nanotubes and double-walled carbon nanotubes.

### Embodiment 11

A method of performing aspects of manufacturing carbon nanotubes, comprising: supplying a catalyst precursor solution and a carrier gas to an injection assembly, the injection assembly including a nozzle and an elongated tubular body having a first conduit and a second conduit in fluid communication with the nozzle, the first conduit and the second conduit extending along a length of the tubular body, one of the first conduit and the second conduit receiving the catalyst precursor solution, another of the first conduit and the second conduit receiving the carrier gas; inserting the length of the tubular body through an end of the reactor to a reaction zone in the reactor and disposing the nozzle in the immediate region of the high temperature reaction zone, and regulating a temperature of the catalyst precursor solution and the carrier gas along the length of the tubular body by a cooling system; nebulizing the catalyst precursor solution to produce a mist including a mixture of the nebulized catalyst precursor solution and the carrier gas; and injecting the mist into the reaction zone when the nozzle is disposed in the reaction zone.

### Embodiment 12

The method of any prior embodiment, further comprising growing nanotubes in the reactor by a floating catalyst thermal chemical vapor deposition process.

### Embodiment 13

The method of any prior embodiment, wherein the first conduit is formed by an injection tube disposed in a central conduit of the tubular body, the second conduit is an annular region of the central conduit around the injection tube.

### Embodiment 14

The method of any prior embodiment, wherein regulating the temperature includes circulating a cooling liquid along the length of the tubular body.

### Embodiment 15

The method of any prior embodiment, wherein the cooling liquid is circulated through a circumferential conduit extending along the length of the tubular body, the circumferential conduit surrounding the first conduit and the second conduit.

### Embodiment 16

The method of any prior embodiment, wherein the first conduit is a central conduit of the tubular body, the second conduit is formed by an injection tube disposed in the central conduit, and the circumferential conduit is formed within a wall of the tubular body.

### Embodiment 17

The method of any prior embodiment, wherein the orifice is configured to nebulize the catalyst precursor solution into droplets having a size that is less than or equal to one micron.

### Embodiment 18

The method of any prior embodiment, wherein the first conduit and the second conduit are configured to isolate the catalyst precursor solution from the carrier gas as the catalyst precursor solution and the carrier gas flow to the nozzle.

### Embodiment 19

The method of any prior embodiment, wherein the first conduit and the second conduit terminate proximate to the orifice, and injecting the mist includes combining the catalyst precursor solution and the carrier gas as the catalyst precursor solution and the carrier gas pass through the orifice.

### Embodiment 20

The method of any prior embodiment, wherein the carbon nanotubes are selected from at least one of single-walled carbon nanotubes and double-walled carbon nanotubes.

In connection with the teachings herein, various analyses and/or analytical components may be used, including digital and/or analog systems. The apparatus may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made, and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. An apparatus for performing aspects of manufacturing carbon nanotubes, comprising:
a nozzle configured to receive a catalyst precursor solution and a carrier gas, the nozzle having a distal end including an orifice configured to nebulize the catalyst precursor solution and produce a mist including a mixture of the nebulized catalyst precursor solution and the carrier gas, the nozzle configured to inject the mist directly into a high temperature reaction zone of a reactor;
an elongated tubular body having a first conduit and a second conduit in fluid communication with the nozzle, the first conduit and the second conduit extending along a length of the tubular body, one of the first conduit and the second conduit connected to a source of a catalyst precursor solution, another of the first conduit and the second conduit connected to a source of the carrier gas, the length of the tubular body being greater than or equal to a distance from an end of the reactor to the reaction zone; and
a cooling system configured to regulate a temperature of the catalyst precursor solution and the carrier gas along the length of the tubular body.

2. The apparatus of claim 1, wherein the apparatus and the reactor are configured to produce carbon nanotubes by a floating catalyst thermal chemical vapor deposition process.

3. The apparatus of claim 1, further comprising an injection tube disposed in a central conduit of the tubular body, the first conduit formed by the injection tube and the second conduit being an annular region of the central conduit around the injection tube.

4. The apparatus of claim 1, wherein the cooling system is configured to circulate a cooling liquid along the length of the tubular body.

5. The apparatus of claim 4, wherein the cooling system includes a circumferential conduit extending along the length of the tubular body and configured to receive the cooling liquid, the circumferential conduit surrounding the first conduit and the second conduit.

6. The apparatus of claim 4, wherein the first conduit is a central conduit of the tubular body, the second conduit is formed by an injection tube disposed in the central conduit, and the circumferential conduit is formed within a wall of the tubular body.

7. The apparatus of claim 1, wherein the orifice is configured to nebulize the catalyst precursor solution into droplets having a size that is less than or equal to one micron.

8. The apparatus of claim 1, wherein the first conduit and the second conduit are configured to isolate the catalyst precursor solution from the carrier gas as the catalyst precursor solution and the carrier gas flow to the nozzle.

9. The apparatus of claim 7, wherein the first conduit and the second conduit terminate proximate to the orifice, so that the catalyst precursor solution and the carrier gas combine as the catalyst precursor solution and the carrier gas pass through the orifice.

10. The apparatus of claim 1, wherein the carbon nanotubes are selected from at least one of single-walled carbon nanotubes and double-walled carbon nanotubes.

11. A method of performing aspects of manufacturing carbon nanotubes, comprising:
supplying a catalyst precursor solution and a carrier gas to an injection assembly, the injection assembly including a nozzle and an elongated tubular body having a first conduit and a second conduit in fluid communication with the nozzle, the first conduit and the second conduit extending along a length of the tubular body, one of the first conduit and the second conduit receiving the catalyst precursor solution, another of the first conduit and the second conduit receiving the carrier gas,
inserting the length of the tubular body through an end of the reactor to a reaction zone in the reactor and disposing the nozzle in the immediate region of the high temperature reaction zone, and regulating a temperature of the catalyst precursor solution and the carrier gas along the length of the tubular body by a cooling system;
nebulizing the catalyst precursor solution to produce a mist including a mixture of the nebulized catalyst precursor solution and the carrier gas; and
injecting the mist into the reaction zone when the nozzle is disposed in the reaction zone.

12. The method of claim 11, further comprising growing nanotubes in the reactor by a floating catalyst thermal chemical vapor deposition process.

13. The method of claim 11, wherein the first conduit is formed by an injection tube disposed in a central conduit of the tubular body, the second conduit is an annular region of the central conduit around the injection tube.

14. The method of claim 11, wherein regulating the temperature includes circulating a cooling liquid along the length of the tubular body.

15. The method of claim 14, wherein the cooling liquid is circulated through a circumferential conduit extending along the length of the tubular body, the circumferential conduit surrounding the first conduit and the second conduit.

16. The method of claim 14, wherein the first conduit is a central conduit of the tubular body, the second conduit is formed by an injection tube disposed in the central conduit, and the circumferential conduit is formed within a wall of the tubular body.

17. The method of claim 11, wherein the orifice is configured to nebulize the catalyst precursor solution into droplets having a size that is less than or equal to one micron.

18. The method of claim 11, wherein the first conduit and the second conduit are configured to isolate the catalyst precursor solution from the carrier gas as the catalyst precursor solution and the carrier gas flow to the nozzle.

19. The method of claim 17, wherein the first conduit and the second conduit terminate proximate to the orifice, and injecting the mist includes combining the catalyst precursor solution and the carrier gas as the catalyst precursor solution and the carrier gas pass through the orifice.

20. The method of claim 11, wherein the carbon nanotubes are selected from at least one of single-walled carbon nanotubes and double-walled carbon nanotubes.
